(19) United States
(12) Patent Application Publication
(10) Pub. No.: US 2026/0196871 A1
(43) Pub. Date: Jul. 9, 2026

(54) SPLIT PLANAR COIL FOR WIRELESS POWER TRANSFER

(71) Applicant: Renesas Electronics America Inc., Milpitas, CA (US)

(72) Inventors: Sheng YUAN, Putuo District, Shanghai (CN); Jiangjian HUANG, Milpitas, CA (US); Bo TANG, Chengdu, Sichuan (CN); Hulong ZENG, San Jose, CA (US)

(73) Assignee: Renesas Electronics America Inc., Milpitas, CA (US)

(21) Appl. No.: 18/835,195

(22) PCT Filed: Mar. 30, 2023
(86) PCT No.: PCT/CN2023/085002

§ 371 Date: Aug. 1, 2024

(51) Int. Cl. H02J 50/00; H01F 27/28; H01F 27/36; H02J 50/10; H02J 50/70

(52) U.S. Cl. CPC H02J 50/005; H01F 27/2804; H01F 27/2828; H01F 27/2871; H01F 27/366; H02J 50/10; H02J 50/70

(57) ABSTRACT

A wireless power apparatus may include a first planar coil having a first coil winding orientation, the first planar coil may be disposed in a plane, a second planar coil may have a second coil winding orientation that is opposite the first coil winding orientation, the second planar coil may be disposed at a distance from the first planar coil in the plane, and a conductor configured to serially connect the first planar coil with the second planar coil to form a split planar coil.

### BACKGROUND

The present disclosure relates in general to systems, apparatuses and methods including wireless power transfer using a split planar coil configuration.

Wireless power transfer (WPT) systems may include a power transmitter having a transmitter coil and a power receiver having a receiver coil. The transmitter coil and the receiver coil may be brought close to one another to form a transformer that may facilitate inductive transmission of alternating current (AC) power. The transfer of AC power, from the transmitter to the receiver, may facilitate powering a device containing the receiver coil, or charging of a battery within the device. An electronic stylus may be used to input data to a tablet computer, laptop computer, or other device. Typically, an electronic stylus may include a bar coil with ferrite having a minimum size due to the brittleness of ferrite leading to a larger volume requirement for incorporating the bar coil within either a charging port for the tablet computer or the electronic stylus itself. Due to cost, weight, volume/size, and complexity, it may be advantageous to charge an electronic stylus in a manner other than using a port on or in the tablet computer, for example. A solution is needed to address these issues and others.

### SUMMARY

In one embodiment, a wireless power system is generally described. The wireless power system may include an alternating current power source configured to provide electrical power, a power transmitter coupled to the alternating current power source, the power transmitter having a transmitter split planar coil coupled to the power transmitter, the transmitter split planar coil including a first planar coil having a first coil winding orientation, the first planar coil being disposed in a plane, a second planar coil having a second coil winding orientation that is opposite the first coil winding orientation, the second planar coil being disposed at a distance from the first planar coil in the plane, and a conductor configured to serially connect the first planar coil with the second planar coil to form the transmitter split planar coil, the power transmitter being configured to wirelessly transmit power through the transmitter split planar coil, a power receiver coupled to a receiver coil, the power receiver being configured to wirelessly receive power from the power transmitter when the receiver coil is in proximity to the transmitter split planar coil, and a load configured to receive power from the power receiver.

In this embodiment, the wireless power system, wherein the receiver coil may be one of a receiver split planar coil and a receiver bar coil. The wireless power system, wherein at least one of the transmitter split planar coil and the receiver split planar coil may further include an elongated substrate configured to support the first planar coil and the second planar coil, the elongated substrate having an elongated substrate first end and an elongated substrate second end, the elongated substrate being configured to support the first planar coil at the elongated substrate first end and support the second planar coil at the elongated substrate second end, wherein the first planar coil and the second planar coil may have a shape that is one of a square shape, a circular shape, a hexagonal shape, a rectangular shape, and an octagonal shape.

In this embodiment, the wireless power system, wherein at least one of the transmitter split planar coil and the receiver split planar may further include a first post disposed at the elongated substrate first end, the first planar coil being mounted around the first post, the first post forming a first core for the first planar coil, and a second post disposed at the elongated substrate second end, the second planar coil being mounted around the second post, the second post forming a second core for the second planar coil.

In this embodiment, the wireless power system, wherein at least one of each of the first post and the second post may include one of a magnetic material, a magnetic shielding material, and a magnetically transparent material, and the elongated substrate may include one of a magnetically transparent material, a magnetic shielding material, and a magnetic material, the receiver split planar coil may be disposed facing the transmitter split planar coil when the receiver split planar coil includes the elongated substrate with at least one of a magnetically transparent material, a magnetic shielding material, and a magnetic material.

In one embodiment, a wireless power apparatus is generally described. The wireless power apparatus may include a first planar coil having a first coil winding orientation, the first planar coil may be disposed in a plane, a second planar coil may have a second coil winding orientation that is opposite the first coil winding orientation, the second planar coil may be disposed at a distance from the first planar coil in the plane, and a conductor configured to serially connect the first planar coil with the second planar coil to form a split planar coil.

In this embodiment, the wireless power apparatus, wherein the first planar coil and the second planar coil may be one of wire-wound and printed circuit coils. In this embodiment, the wireless power apparatus, may further include an elongated substrate configured to support the first planar coil and the second planar coil, the elongated substrate may have an elongated substrate first end and an elongated substrate second end, the elongated substrate may be configured to support the first planar coil at the elongated substrate first end and support the second planar coil at the elongated substrate second end.

In this embodiment, the wireless power apparatus, wherein the elongated substrate may include at least one of a magnetically transparent material, a magnetic shielding material, and a magnetic material. In this embodiment, the wireless power apparatus, may further include a first post disposed at the elongated substrate first end, the first planar coil being mounted around the first post, the first post forming a first core for the first planar coil, and a second post disposed at the elongated substrate second end, the second planar coil being mounted around the second post, the second post forming a second core for the second planar coil.

In this embodiment, the wireless power apparatus, wherein each of the first post and the second post may include at least one of a magnetic material, a magnetic shielding material, and a magnetically transparent material. In this embodiment, the wireless power apparatus, wherein at least one of the magnetic material may include ferrite, the magnetic shielding material may include nanocrystalline material, and the magnetically transparent material may include plastic.

In this embodiment, the wireless power apparatus, wherein the first planar coil and the second planar coil may have a shape that is one of a square shape, circular shape, a hexagonal shape, a rectangular shape, and an octagonal shape. In this embodiment, the wireless power apparatus, wherein the first planar coil and the second planar coil have an air core region.

In this embodiment, the wireless power apparatus, may further include a power transmitter coupled to the split planar coil, the power transmitter being configured to receive electrical power from an alternating current power source, wherein the power transmitter may be configured to wirelessly transmit power from the alternating current power source through the split planar coil.

In one embodiment, a method for constructing a wireless power apparatus is generally described. The method may include a method for constructing a wireless power apparatus, the method may include forming a first planar coil having a first coil winding orientation, the first planar coil being disposed in a plane, forming a second planar coil having a second coil winding orientation that is opposite the first coil winding orientation, the second planar coil being disposed at a distance from the first planar coil in the plane, and connecting the first planar coil and the second planar coil together serially to form a split planar coil.

In this embodiment, the method for constructing a wireless power apparatus, wherein the first planar coil and the second planar coil are formed having a shape that is one of a square shape, a circular shape, a hexagonal shape, a rectangular shape, and an octagonal shape.

In this embodiment, the method for constructing a wireless power apparatus, may include forming an elongated substrate configured to support the first planar coil and the second planar coil, the elongated substrate having an elongated substrate first end and an elongated substrate second end, the elongated substrate being configured to support the first planar coil at the elongated substrate first end and support the second planar coil at the elongated substrate second end, wherein the elongated substrate includes at least one of a magnetically transparent material, a magnetic shielding material, and a magnetic material.

In this embodiment, the method for constructing a wireless power apparatus, may include forming a first post disposed at the elongated substrate first end, the first planar coil may be mounted around the first post, the first post forming a first core for the first planar coil, and forming a second post disposed at the elongated substrate second end, the second planar coil being mounted around the second post, the second post forming a second core for the second planar coil. In this embodiment, the method for constructing a wireless power apparatus, may include each of the first post and the second post may have one of a magnetic material, a magnetic shielding material, and a magnetically transparent material.

Further features as well as the structure and operation of various embodiments are described in detail below with reference to the accompanying drawings. In the drawings, like reference numbers may indicate identical or functionally similar elements.

### BRIEF DESCRIPTION OF THE DRAWINGS

FIG. 1 is a block diagram of an example wireless power system according to an embodiment.

FIG. 2A is a diagram showing a perspective view of components of an example split planar coil according to an embodiment.

FIG. 2B is a diagram showing a perspective view of components of an example split planar coil with an elongated substrate according to an embodiment.

FIG. 2C is a diagram showing a perspective view of components of an example elongated substrate according to an embodiment.

FIG. 3A is a diagram showing components of an example split planar coil illustrating coarse opposite winding directions according to an embodiment.

FIG. 3B is a diagram showing components of an example split planar coil illustrating circular split planar coils according to an embodiment.

FIG. 3C is a diagram showing components of an example split planar coil illustrating circular split planar coils having core regions according to an embodiment.

FIG. 3D is a diagram showing components of an example split planar coil illustrating square split planar coils having core regions according to an embodiment.

FIG. 3E is a diagram showing components of example planar coils illustrating a hexagonal planar coil having a core region, a rectangular planar coil having a core region, and an octagonal planar coil having a core region according to various embodiments.

FIG. 4A is a diagram showing a side view of an example split planar coil in an energized state according to an embodiment.

FIG. 4B is a diagram showing a side view of an example split planar coil with an elongated substrate having a magnetically insulating material, the example split planar coil being in an energized state according to an embodiment.

FIG. 5A is a diagram showing a perspective view of an example transmitter split planar coil adjacent to an example receiver split planar coil according to an embodiment.

FIG. 5B is a diagram showing a perspective view of an example transmitter split planar coil adjacent to an example receiver bar coil according to an embodiment.

FIG. 6A is a diagram showing a side view of an example transmitter power system adjacent to a receiver power system according to an embodiment.

FIG. 6B is a diagram showing a side view of an example transmitter power system adjacent to another receiver power system according to an embodiment.

FIG. 7 illustrate a flow diagram of a method of constructing a wireless power apparatus according to an embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

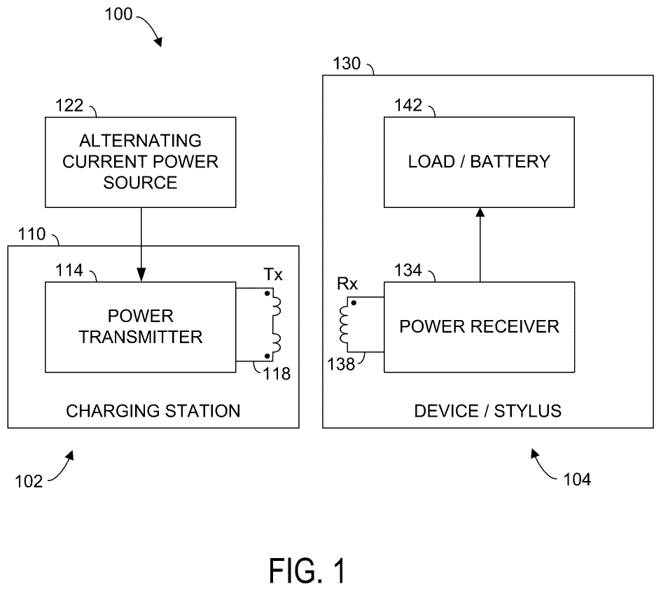

FIG. 1 is a block diagram of an example wireless power system according to an embodiment. A wireless power system 100 may include an alternating current power source 122 configured to provide electrical power. Wireless power system 100 may also include a charging station 110 with a power transmitter 114 coupled to alternating current power source 122. Power transmitter may include a transmitter split planar coil 118 configured to conduct and radiate electrical energy. Wireless power system 100 may also include a device 130, such as a hand-held electronic stylus (e.g., electronic pen input device) for use in entering data to a tablet computer (not shown), a battery, or other rechargeable electronic component. Device 130 may include a power receiver 134 coupled to a receiver coil 138. Power receiver 134 may be configured to wirelessly receive power from power transmitter 114 when receiver coil 138 is in proximity to an energized transmitter split planar coil 118. Device 130 may also include a load 142 configured to receive power from power receiver 134 such as a battery for storing electrical energy received in the process of charging device 130 through charging station 110, for example. In this manner, power from alternating current power source 122 may be transferred to load 142 via inductive coupling between transmitter split planar coil 118 and receiver coil 138 which may form a transformer so that wireless power transfer (WPT) may be accomplished using a near field power transfer technique.

Load 142 may also include various power conditioning components for use in power regulation and/or distribution to various internal components of device 130 including a battery. Charging device 130, such as charging a stylus, may include laying the stylus down in a proper orientation on or near charging station 110. Alternatively, charging station 110 may be incorporated into a tablet computer, laptop computer, or other portable electronic device having a mount or receptacle for receiving, retaining, and charging the stylus, for example. Alternatively, Load 142 may be located outside of device 130 and could be coupled to power receiver 134 directly or indirectly. A power transmitter system 102 may include some or all of the components described in reference to power transmitter 114, including charging station 110, power transmitter 114, transmitter split planar coil 118, and alternating current power source 122, and the like. Similarly, power receiver system 104 may include some or all of the components described in reference to power receiver 134, including device or stylus 130, power receiver 134, receiver coil 138, and load or battery 142, and the like,

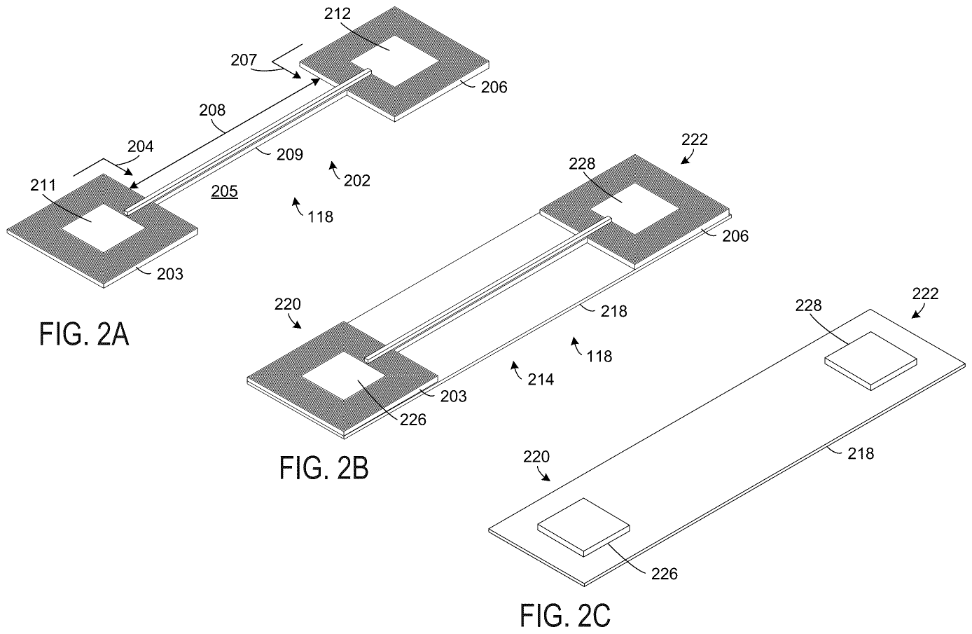

FIG. 2A is a diagram showing a perspective view of components of an example split planar coil according to an embodiment. In reference to FIG. 1 to FIG. 2A, transmitter split planar coil 118 may include a split planar coil 202 with a first planar coil 203 (e.g., a transmitter conductor) that may have a first coil winding orientation 204. As described, first coil winding orientation 204 may describe the direction of a coil winding, such as the coil being wound in a clock-wise or right-hand manner when viewed from a top plan view, for example. Alternatively, first coil winding orientation 204 may be wound in a counter clock-wise or left-hand manner when viewed from a top plan view, as will be described more fully below. First planar coil 203 may be located or disposed in a plane 205.

Split planar coil 202 may also include a second planar coil 206 that may have a second coil winding orientation 207 that is opposite the first coil winding orientation. In this manner, second coil winding orientation 207 may be wound in a counter clock-wise or left-hand manner when viewed from a top plan view. Alternatively, second coil winding orientation 207 may be wound in a clock-wise or right-hand manner when viewed from a top plan view. Second planar coil 206 may be located or disposed at a distance 208 from first planar coil 203 in plane 205. Finally, split planar coil 202 may include a conductor 209 that is configured to serially connect a second lead or terminal of first planar coil 203 with a first lead or terminal of second planar coil 206 to form transmitter split planar coil 202. In this manner, first planar coil 203 conductor 209 and second planar coil 206 may form a continuous electrical path through transmitter split planar coil 202. A first lead or terminal of first planar coil 203 and a second lead or terminal of second planar coil 206 may be connected to power transmitter 114 so that power transmitter 114 may be configured to wirelessly transmit power through transmitter split planar coil 202. In one example, first planar coil 203 and second planar coil 206 may be implemented as wire-wound or printed circuit coils. A wire-wound may be formed as a thin, single conductor or other conductor wrapped multiple times around a core region, in accordance with various embodiments disclosed herein. In another example, a printed circuit coil may be formed as a flexible printed circuit (FPC) that may include one or more conducting paths that are printed or deposited on a substrate such as a copper trace with a dielectric layer such as polyimide, or the FPC may be bonded to an insulating substrate using an adhesive. A FPC may be covered or sandwiched with a protective layer thereby forming an insulated conducting path similar to a wire. Advantageously, FPC may be formed in arbitrary shapes, including coils, so that one or more coil layers may be formed as an FPC, in accordance with various embodiments disclosed herein. First planar coil 203 may have a first air core region 211, while second planar coil 206 may have a second air core region 212. In one example, first air core region 211 and second air core region 212 may be supported by a magnetically transparent material such as plastic formed in corresponding circular, square, rectangular, hexagonal, or octagonal shape.

FIG. 2B is a diagram showing a perspective view of components of an example split planar coil with an elongated substrate according to an embodiment. In reference to FIG. 1 to FIG. 2B, transmitter split planar coil 118 may include a split planar coil 214 with an elongated substrate 218 having an elongated substrate first end 220 configured to support first planar coil 203 and having an elongated substrate second end 222 configured to support second planar coil 206. Elongated substrate 218 may include a magnetically transparent material such as plastic, a magnetic shielding material such as a nanocrystalline material, a magnetic material such as ferrite (e.g., compound of iron oxide), or a combination of one or more of magnetically transparent material, magnetic shielding material, and magnetic material. Elongated substrate 218 may include a first post 226 disposed at elongated substrate first end 220 where first planar coil 203 may be mounted around first post 226 to form a first core for first planar coil 203. Elongated substrate 218 may also include a second post 228 disposed at elongated substrate second end 222 where second planar coil 206 may be mounted around second post 228 to form a second core for second planar coil 206.

FIG. 2C is a diagram showing a perspective view of components of an example elongated substrate according to an embodiment. First post 226 located at elongated substrate first end 220 and second post 228 may be located at elongated substrate second end 222. First post 226 and second post 228 may include a magnetically transparent material such as plastic, a magnetic shielding material such as a nanocrystalline material, a magnetic material such as ferrite (e.g., a section of ferrite sheet), or a combination of one or more of magnetically transparent material, magnetic shielding material, and magnetic material.

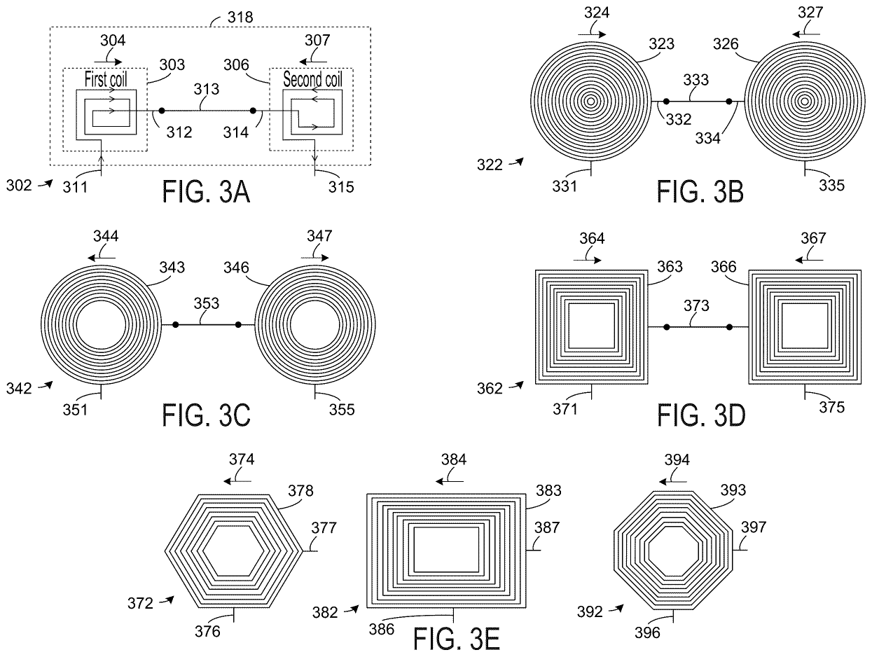

FIG. 3A is a diagram showing components of an example split planar coil illustrating coarse opposite winding directions according to an embodiment. A split planar coil 302 may include a first planar coil 303 that may have a first coil winding orientation 304 and may be related to the direction of the coil conductor outermost edge of first planar coil 303 (e.g., clock-wise), First planar coil 303 may be located or disposed in a plane. Split planar coil 302 may also include a second planar coil 306 that may have a second coil winding orientation 307 that is opposite first coil winding orientation 304 and may be related to the direction of the coil conductor outermost edge of second planar coil 306 (e.g., counter clock-wise). A conductor of first planar coil 303 may include a first lead 311 and a second lead 312. A conductor of second planar coil 306 may include a first lead 314 and a second lead 315. Split planar coil 302 may also include a conductor 313 to connect first planar coil 303 second lead 312 to second planar coil 306 first lead 314 to form a continuous conduction path from first lead 311 to first planar coil 303 to conductor 313 to second planar coil 306 to second planar coil second lead 315. Conductor 313 may be formed of the same or different materials from first planar coil 303 and second planar coil 306. Split planar coil 302 may include an elongated substrate 318 configured to support first planar coil 303 and second planar coil 306. Elongated substrate 318 may include a magnetically transparent material such as plastic, a magnetic shielding material such as a nanocrystalline material, a magnetic material such as ferrite, or a combination of one or more of magnetically transparent material, magnetic shielding material, and magnetic material. FIG. 3A graphically illustrates opposite winding directions for first planar coil 303 and second planar coil 306.

FIG. 3B is a diagram showing components of an example split planar coil illustrating circular split planar coils according to an embodiment. A split planar coil 322 may include a first planar coil 303 in a circular configuration that may have a first coil winding orientation 324. First planar coil 323 may be located or disposed in a plane. Split planar coil 322 may also include a second planar coil 326 in a circular configuration that may have a second coil winding orientation 327 that is opposite first coil winding orientation 324. First coil winding orientation 324 and second coil winding orientation 327 may be opposite those of split planar coil 302 illustrated with brief reference to FIG. 3A or other embodiments, for example. A conductor of first planar coil 323 may include a first lead 331 and a second lead 332. A conductor of second planar coil 326 may include a first lead 334 and a second lead 335. Split planar coil 322 may also include a conductor 333 to connect first planar coil 323 second lead 332 to second planar coil 326 first lead 334 to form a continuous conduction path from first lead 331 to first planar coil 323 to conductor 333 to second planar coil 326 to second planar coil second lead 335. Conductor 333 may be formed of the same or different materials from first planar coil 323 and second planar coil 326. Alternatively, conductor 333 may be formed by connecting second lead 332 directly to first lead 334. In yet another alternative, the continuous conduction path from first lead 331 to second lead 335 may be formed with a single conductor formed as described. Split planar coil 322 may include an elongated substrate configured to support first planar coil 323 and second planar coil 326. FIG. 3B graphically illustrates first planar coil 323 and second planar coil 326 having a continuous coil without a core region.

FIG. 3C is a diagram showing components of an example split planar coil illustrating circular split planar coils having core regions according to an embodiment. A split planar coil 342 may include a first planar coil 343 in a circular configuration that may have a first coil winding orientation 344 and having a core region. First planar coil 343 may be located or disposed in a plane. Split planar coil 342 may also include a second planar coil 346 in a circular configuration that may have a second coil winding orientation 347 that is opposite first coil winding orientation 344. A conductor of first planar coil 343 may include a first lead 351 and a second lead. A conductor of second planar coil 346 may include a first lead and a second lead 355. Split planar coil 342 may also include a conductor 353 to connect first planar coil 343 second lead to second planar coil 346 first lead to form a continuous conduction path from first lead 351 to first planar coil 343 to conductor 353 to second planar coil 346 to second planar coil second lead 355. Conductor 353 may be formed of the same or different materials from first planar coil 343 and second planar coil 346. Split planar coil 342 may include an elongated substrate configured to support first planar coil 343 and second planar coil 346.

FIG. 3D is a diagram showing components of an example split planar coil illustrating square split planar coils having core regions according to an embodiment. A split planar coil 362 may include a first planar coil 363 in a square configuration that may have a first coil winding orientation 364 and having a core region. First planar coil 363 may be located or disposed in a plane. Split planar coil 362 may also include a second planar coil 366 in a square configuration that may have a second coil winding orientation 367 that is opposite first coil winding orientation 364. A conductor of first planar coil 363 may include a first lead 371 and a second lead. A conductor of second planar coil 366 may include a first lead and a second lead 375. Split planar coil 362 may also include a conductor 373 to connect first planar coil 363 second lead to second planar coil 366 first lead to form a continuous conduction path from first lead 371 to first planar coil 363 to conductor 373 to second planar coil 366 to second planar coil second lead 375. Conductor 373 may be formed of the same or different materials from first planar coil 363 and second planar coil 366. Split planar coil 362 may include an elongated substrate configured to support first planar coil 363 and second planar coil 366.

FIG. 3E is a diagram showing components of example planar coils illustrating a hexagonal planar coil having a core region, a rectangular planar coil having a core region, and an octagonal planar coil having a core region according to various embodiments. A partial view of split planar coil 372 may include a first planar coil 378 in a hexagonal configuration that may have a first coil winding orientation 374 having a core region. First planar coil 378 may be paired with a second planar coil in a hexagonal configuration (not shown) with a second coil winding orientation and having a core region. First planar coil 378 may include a first lead 376 and a second lead 377. A partial view of split planar coil 382 may include a first planar coil 383 in a rectangular configuration that may have a first coil winding orientation 384 having a core region. First planar coil 383 may be paired with a second planar coil in a rectangular configuration (not shown) with a second coil winding orientation and having a core region. First planar coil 383 may include a first lead 386 and a second lead 387. Finally, a partial view of split planar coil 392 may include a first planar coil 393 in an octagonal configuration that may have a first coil winding orientation 394 having a core region. First planar coil 393 may be paired with a second planar coil in an octagonal configuration (not shown) with a second coil winding orientation and having a core region. First planar coil 393 may include a first lead 396 and a second lead 397. Thus, FIG. 3A through FIG. 3E illustrate planar coils having a square shape, circular shape, hexagonal shape, rectangular shape, and octagonal shape, and a split planar coil arrangement with or without an elongated substrate.

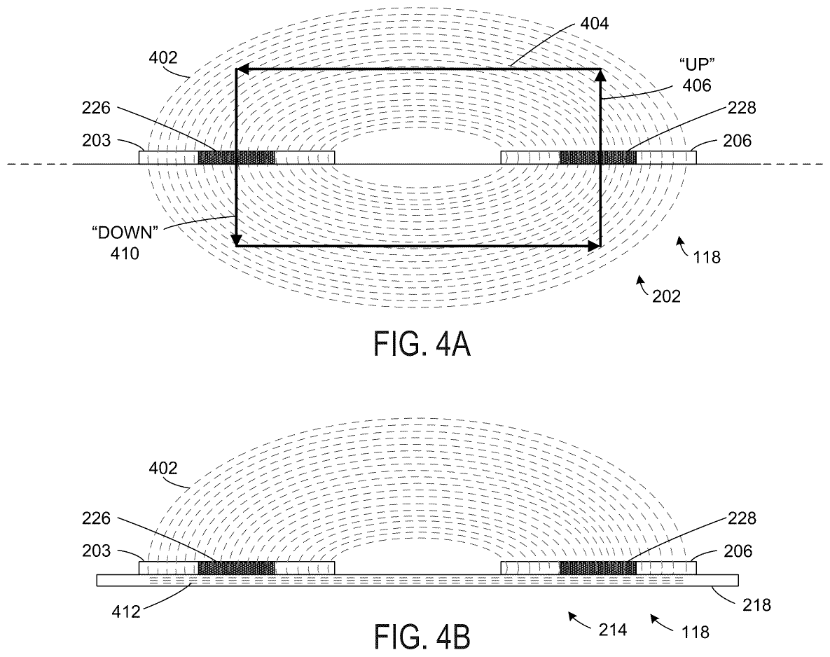

FIG. 4A is a diagram showing a side view of an example split planar coil in an energized state according to an embodiment. In reference to FIG. 1 through FIG. 4A, a split planar coil 202 may include a first planar coil 203 and a second planar coil 206 that when energized by power transmitter 114 to emit a magnetic field 402 having a circulating magnetic field 404 having an “up” direction 406 from second planar coil 206 and a “down” direction 410 from first planar coil 203. Depending on first coil winding orientation 204 and second coil winding orientation 207, the direction of circulating magnetic field 404 may be reversed.

FIG. 4B is a diagram showing a side view of an example split planar coil with an elongated substrate having a magnetically insulating material, the example split planar coil being in an energized state according to an embodiment. In reference to FIG. 1 through FIG. 4B, a split planar coil 214 may include a first planar coil 203 and a second planar coil 206 that when energized by power transmitter 114 to emit a magnetic field 402 in a direction above (as illustrated) elongated substrate 218 which may include a magnetic shielding material such as a nanocrystalline material, a magnetic material such as ferrite, or a combination magnetic shielding material and magnetic material. In this manner, electronically sensitive components may be insulated by the magnetic shielding material in elongated substrate 218, or may be insulated by the magnetic material in elongated substrate 218 by conducting the emitted magnetic field in a region 412 of elongated substrate 218 between first planar coil 203 and second planar coil 206. Such electronically sensitive components may be located in a tablet computer, a laptop computer, or other device. Power transmitter 114 may be configured to receive electrical power from alternating current power source 122, wherein the power transmitter is configured to wirelessly transmit power from alternating current power source 122 through any of the various split planar coils described herein.

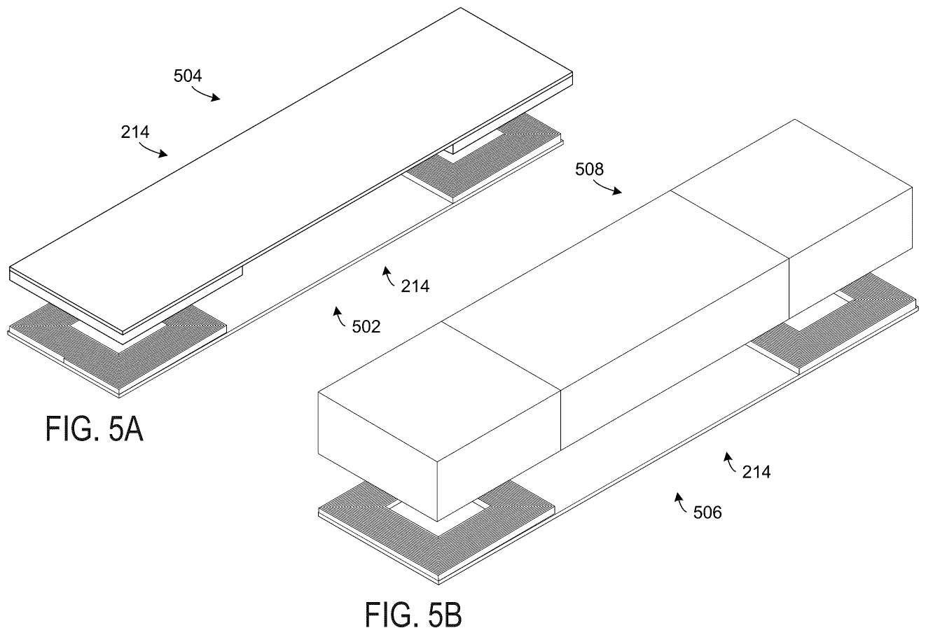

FIG. 5A is a diagram showing a perspective view of an example transmitter split planar coil adjacent to an example receiver split planar coil according to an embodiment. In reference to FIG. 1 through FIG. 5A, a first split planar coil 214 may be designated as a transmitter split planar coil 502 while a second split planar coil 214 may be designated as a receiver split planar coil 504 disposed adjacent to, aligned with, and facing transmitter split planar coil 502. In this manner, electrical power may be wirelessly transmitted from transmitter split planar coil 502 to receiver split planar coil 504.

FIG. 5B is a diagram showing a perspective view of an example transmitter split planar coil adjacent to an example receiver bar coil according to an embodiment. In reference to FIG. 1 through FIG. 5B, split planar coil 214 may be designated as a transmitter split planar coil 506 while a receiver bar coil 508 may be disposed adjacent to and aligned with transmitter split planar coil 506. In this manner, electrical power may be wirelessly transmitted from transmitter split planar coil 506 to receiver bar coil 508.

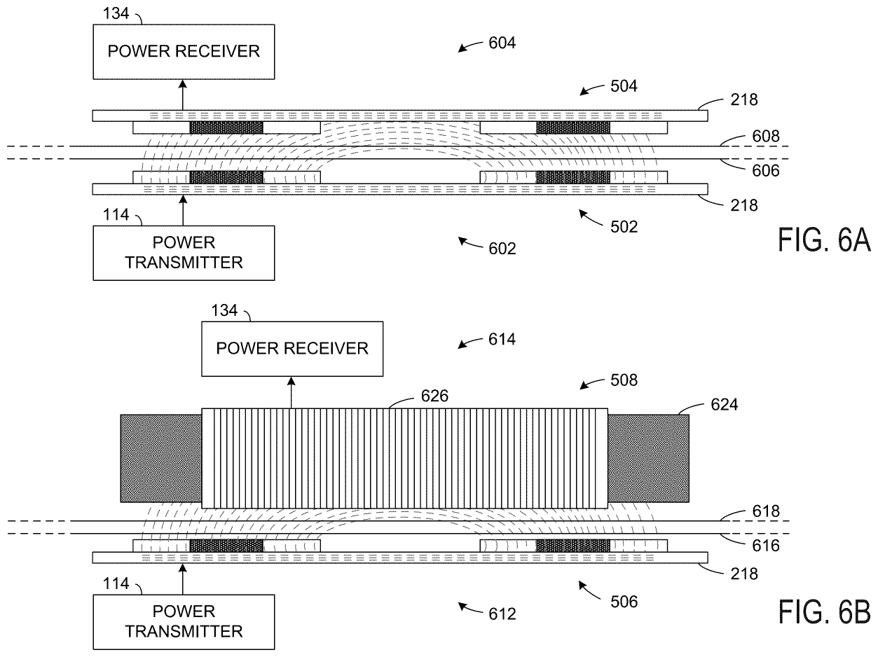

FIG. 6A is a diagram showing a side view of an example transmitter power system adjacent to a receiver power system according to an embodiment. In reference to FIG. 1 through FIG. 6A, transmitter split planar coil 502 may be disposed adjacent to, aligned with, and facing receiver split planar coil 504. Power transmitter 114 may be coupled to transmitter split planar coil 502 to form transmitter power system 602, while power receiver 134 may be coupled to receiver split planar coil 504 to form receiver power system 604. In this manner, electrical power may be wirelessly transmitted from transmitter power system 602 to receiver power system 604. Transmitter split planar coil 502 may include elongated substrate 218 having a magnetically insulating material such as a nanocrystalline material, and receiver split planar coil 504 may include elongated substrate 218 having a magnetically insulating material. In this manner, sensitive electronic components may be shielded from magnetic fields generated by transmitter split planar coil 502 and received by receiver split planar coil 504. Transmitter split planar coil 502 may be mounted on or adjacent to a first boundary 606 such as a magnetically transparent covering or shell for transmitter power system 602. Similarly, receiver split planar coil 504 may be mounted on or adjacent to a second boundary 608 such as a magnetically transparent covering or shell for receiver power system 604 which may be a charging pad for an electronic stylus, for example. Using a charging pad may avoid the cost, weight, volume/size, and complexity of including a stylus charging port in a tablet computer, laptop computer, or other electronic device that uses an electronic stylus, for example. The low profile, and smaller volume of both transmitter split planar coil 502 and receiver split planar coil 504 may reduce the size, weight, and cost of providing wireless charging of an electronic stylus or other device, among other benefits.

FIG. 6B is a diagram showing a side view of an example transmitter power system adjacent to another receiver power system according to an embodiment. In reference to FIG. 1 through FIG. 6B, transmitter split planar coil 506 may be disposed adjacent to and aligned with receiver bar coil 508. Power transmitter 114 may be coupled to transmitter split planar coil 506 to form transmitter power system 612, while power receiver 134 may be coupled to receiver bar coil 508 to form receiver power system 614. Receiver bar coil 508 may include a ferrite bar 624 wrapped in a spiral manner and surrounded by a coil 626 with leads that are coupled to power receiver 134. In this manner, electrical power may be wirelessly transmitted from transmitter power system 612 to receiver power system 614. Transmitter split planar coil 506 may include elongated substrate 218 having a magnetically insulating material such as a nanocrystalline material. In this manner, sensitive electronic components may be shielded from magnetic fields generated by transmitter split planar coil 506. Transmitter split planar coil 506 may be mounted on or adjacent to a first boundary 616 such as a magnetically transparent covering or shell for transmitter power system 612. Similarly, receiver bar coil 508 may be mounted on or adjacent to a second boundary 618 such as a magnetically transparent covering or shell for receiver power system 614. The low profile, and smaller volume of transmitter split planar coil 506, and compatibility with receiver bar coil 508 may reduce the size, weight, and cost of providing wireless charging of an electronic stylus or other device, among other benefits.

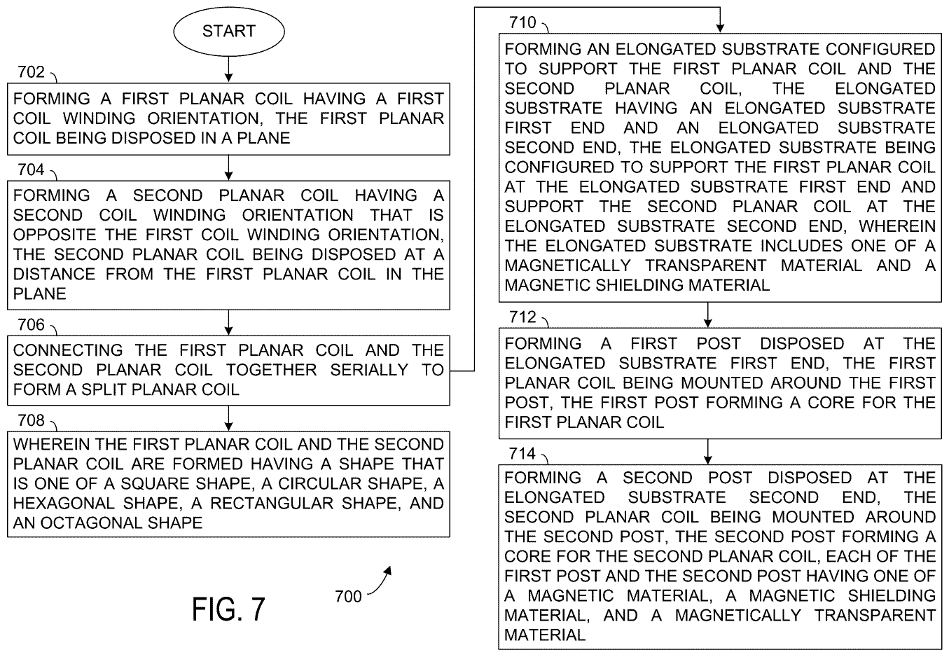

FIG. 7 illustrate a flow diagram of a method of constructing a wireless power apparatus according to an embodiment. In reference to FIG. 1 to FIG. 7, a method 700 for constructing a wireless power apparatus 102 may begin in step 702 with forming a first planar coil 203 having a first coil winding orientation 204, the first planar coil may be disposed in a plane 205. Method 700 may continue in step 704 with forming a second planar coil 206 having a second coil winding orientation 207 that may be opposite the first coil winding orientation 204. Second planar coil may be disposed at a distance 208 from first planar coil 203 in plane 205. Method 700 may continue in step 706 with connecting first planar coil 203 and second planar coil 206 together serially to form a split planar coil 202.

Method 700 may continue in step 708, wherein first planar coil 203 and second planar coil 206 may be formed having a shape that is one of a square shape, a circular shape, a hexagonal shape, a rectangular shape, and an octagonal shape.

Alternatively, from step 706 method 700 may continue in step 710 with forming an elongated substrate 218 configured to support first planar coil 203 and second planar coil 206. Elongated substrate 218 may have an elongated substrate first end 220 and an elongated substrate second end 222. Elongated substrate 218 may be configured to support first planar coil 203 at elongated substrate first end 220 and support second planar coil 206 at elongated substrate second end 222. Elongated substrate 218 may include one of a magnetically transparent material and a magnetic shielding material.

Method 700 may continue in step 712 with forming a first post 226 disposed at elongated substrate first end 220. First planar coil 203 may be mounted around first post 226 and forming a first core for first planar coil 203. Method 700 may conclude in step 714 with forming a second post 228 that may be disposed at elongated substrate second end 222. Second planar coil 206 being mounted around second post 228. Second post 228 may form a second core for the second planar coil. First post 226 and second post 228 may have a magnetic material, a magnetic shielding material, and a magnetically transparent material.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A wireless power apparatus, comprising:
a first planar coil having a first coil winding orientation, the first planar coil being disposed in a plane;
a second planar coil having a second coil winding orientation that is opposite the first coil winding orientation, the second planar coil being disposed at a distance from the first planar coil in the plane; and
a conductor configured to serially connect the first planar coil with the second planar coil to form a split planar coil.

2. The wireless power apparatus of claim 1,
wherein the first planar coil and the second planar coil are one of wire-wound and printed circuit coils.

3. The wireless power apparatus of claim 1, further comprising;
an elongated substrate configured to support the first planar coil and the second planar coil, the elongated substrate having an elongated substrate first end and an elongated substrate second end, the elongated substrate being configured to support the first planar coil at the elongated substrate first end and support the second planar coil at the elongated substrate second end.

4. The wireless power apparatus of claim 3,
wherein the elongated substrate includes at least one of a magnetically transparent material, a magnetic shielding material, and a magnetic material.

5. The wireless power apparatus of claim 3, further comprising:
a first post disposed at the elongated substrate first end, the first planar coil being mounted around the first post, the first post forming a first core for the first planar coil; and
a second post disposed at the elongated substrate second end, the second planar coil being mounted around the second post, the second post forming a second core for the second planar coil.

6. The wireless power apparatus of claim 5,
wherein each of the first post and the second post includes at least one of a magnetic material, a magnetic shielding material, and a magnetically transparent material.

7. The wireless power apparatus of claim 6, wherein at least one of:
the magnetic material includes ferrite;
the magnetic shielding material includes nanocrystalline material; and
the magnetically transparent material includes plastic.

8. The wireless power apparatus of claim I,
wherein the first planar coil and the second planar coil have a shape that is one of a square shape, circular shape, a hexagonal shape, a rectangular shape, and an octagonal shape.

9. The wireless power apparatus of claim 8, wherein the first planar coil and the second planar coil have an air core region.

10. The wireless power apparatus of claim 1, further comprising;
a power transmitter coupled to the split planar coil, the power transmitter being configured to receive electrical power from an alternating current power source, wherein the power transmitter is configured to wirelessly transmit power from the alternating current power source through the split planar coil.

11. A method for constructing a wireless power apparatus, the method comprising:
forming a first planar coil having a first coil winding orientation, the first planar coil being disposed in a plane;
forming a second planar coil having a second coil winding orientation that is opposite the first coil winding orientation, the second planar coil being disposed at a distance from the first planar coil in the plane; and
connecting the first planar coil and the second planar coil together serially to form a split planar coil.

12. The method of claim 11,
wherein the first planar coil and the second planar coil are formed having a shape that is one of a square shape, a circular shape, a hexagonal shape, a rectangular shape, and an octagonal shape.

13. The method of claim 11,
forming an elongated substrate configured to support the first planar coil and the second planar coil, the elongated substrate having an elongated substrate first end and an elongated substrate second end, the elongated substrate being configured to support the first planar coil at the elongated substrate first end and support the second planar coil at the elongated substrate second end, wherein the elongated substrate includes at least one of a magnetically transparent material, a magnetic shielding material, and a magnetic material.

14. The method of claim 13,
forming a first post disposed at the elongated substrate first end, the first planar coil being mounted around the first post, the first post forming a first core for the first planar coil; and
forming a second post disposed at the elongated substrate second end, the second planar coil being mounted around the second post, the second post forming a second core for the second planar coil.

15. The method of claim 14,
each of the first post and the second post having at least one of a magnetic material, a magnetic shielding material, and a magnetically transparent material.

16. A wireless power system, comprising:
an alternating current power source configured to provide electrical power;
a power transmitter coupled to the alternating current power source, the power transmitter having a transmitter split planar coil coupled to the power transmitter, the transmitter split planar coil including:
a first planar coil having a first coil winding orientation, the first planar coil being disposed in a plane;
a second planar coil having a second coil winding orientation that is opposite the first coil winding orientation, the second planar coil being disposed at a distance from the first planar coil in the plane; and
a conductor configured to serially connect the first planar coil with the second planar coil to form the transmitter split planar coil, the power transmitter being configured to wirelessly transmit power through the transmitter split planar coil;
a power receiver coupled to a receiver coil, the power receiver being configured to wirelessly receive power from the power transmitter when the receiver coil is in proximity to the transmitter split planar coil; and
a load configured to receive power from the power receiver.

17. The wireless power system of claim 16,
wherein the receiver coil is one of a receiver split planar coil and a receiver bar coil.

18. The wireless power system of claim 17, wherein at least one of the transmitter split planar coil and the receiver split planar coil further comprises:
an elongated substrate configured to support the first planar coil and the second planar coil, the elongated substrate having an elongated substrate first end and an elongated substrate second end, the elongated substrate being configured to support the first planar coil at the elongated substrate first end and support the second planar coil at the elongated substrate second end,
wherein the first planar coil and the second planar coil have a shape that is one of a square shape, a circular shape, a hexagonal shape, a rectangular shape, and an octagonal shape.

19. The wireless power system of claim 18, wherein at least one of the transmitter split planar coil and the receiver split planar coil further comprises:
a first post disposed at the elongated substrate first end, the first planar coil being mounted around the first post, the first post forming a first core for the first planar coil; and
a second post disposed at the elongated substrate second end, the second planar coil being mounted around the second post, the second post forming a second core for the second planar coil.

20. The wireless power system of claim 19, wherein at least one of:
each of the first post and the second post includes at least one of a magnetic material, a magnetic shielding material, and a magnetically transparent material; and
the elongated substrate includes one of a magnetically transparent material, a magnetic shielding material, and a magnetic material, the receiver split planar coil being disposed facing the transmitter split planar coil when the receiver split planar coil includes the elongated substrate with one of a magnetically transparent material, a magnetic shielding material, and a magnetic material.
